(19) United States
(12) Patent Application Publication
(10) Pub. No.: US 2026/0021550 A1
(43) Pub. Date: Jan. 22, 2026

(54) CUTTING TOOL AND HANDHELD TOOL

(71) Applicant: Nanjing Chervon Industry Co., Ltd., Nanjing (CN)

(72) Inventors: Kun Ji, Nanjing (CN); Bing Lu, Nanjing (CN); Jie Guo, Nanjing (CN)

(21) Appl. No.: 19/259,020

(22) Filed: Jul. 3, 2025

(30) Foreign Application Priority Data
Jul. 19, 2024 (CN) 202421725834.4

(51) Int. Cl. B24B 27/08; B24B 55/05; B25F 5/00; B25F 5/02

(52) U.S. Cl. CPC B24B 27/08; B24B 55/052; B25F 5/02; B25F 5/001

(57) ABSTRACT

A cutting tool includes a trunk assembly, an electric motor, a second housing for accommodating the electric motor, an output shaft for mounting a cutting piece, a transmission assembly connected between a motor shaft and the output shaft, and a third housing for accommodating at least part of the transmission assembly. In a process of the cutting piece cutting a workpiece, the third housing has a first contact surface and a second contact surface with the workpiece; when the first contact surface or the second contact surface is in contact with the workpiece, the cutting piece has a maximum cutting depth; and the angle between the first contact surface and the second contact surface is greater than or equal to 50° and less than or equal to 85°, and the maximum cutting depth is greater than or equal to 20 mm.

### RELATED APPLICATION INFORMATION

This application claims the benefit under 35 U.S.C. § 119 (a) of Chinese Patent Application No. CN 202421725834.4, filed on Jul. 19, 2024, which application is incorporated herein by reference in its entirety.

### BACKGROUND

A power tool is a mechanized tool in which an electric motor or an electromagnet provides power and drives a work head via a transmission mechanism. The power tool can be held and operated by hand, where the electric motor or the electromagnet with low power provides power and drives the work head via the transmission mechanism. To facilitate use even under relatively dim light, an existing power tool is generally provided with a lighting device.

To prevent debris, wooden boards, or grass clippings after grinding or cutting from flying around, prevent the breakage of work head accessories such as a grinding disc, a saw blade, and a cutting disc due to some reasons, and prevent users from being accidentally injured by the saw blade, cutting tools such as an angle grinder and a cutter are typically provided with cutting shields.

When a cutting tool is cutting a workpiece, a maximum cutting depth that the cutting tool can reach is limited. During cutting, when a cutting piece such as the cutting disc gradually approaches the workpiece and cuts increasingly deeper, structures of the cutting tool, such as a housing and the cutting shield, eventually fit with the workpiece, and thus the cutting piece cannot cut deeper and reaches the maximum cutting depth. Therefore, an external design of the cutting tool affects the maximum cutting depth that the cutting tool can reach. Additionally, the external design of the cutting tool also affects a range of a cutting angle. Users often desire the cutting tool to have both a relatively large cutting depth and a relatively large cutting angle.

During use of some cutting tools, the user can operate the cutting disc to the maximum cutting depth only when the cutting shield is adjusted to limit positions at two ends, and when the cutting shield is at other positions, the cutting tool cannot reach the maximum cutting depth even if the cutting tool goes deep until the housing and the like abut against the workpiece.

### SUMMARY

A cutting tool includes a trunk assembly including at least a first housing for a hand grip; and a head assembly including an electric motor; a second housing configured to accommodate the electric motor; an output shaft to which a cutting piece for cutting a workpiece is mounted; and a transmission assembly connected between a motor shaft and the output shaft and configured to transmit a drive force from the electric motor to the output shaft. The cutting tool further includes a third housing for accommodating at least part of the transmission assembly, where in a process of the cutting piece cutting the workpiece, the third housing has a first contact surface and a second contact surface with the workpiece; in the case where the first contact surface or the second contact surface is in contact with the workpiece, the cutting piece has a maximum cutting depth; and the angle between the first contact surface and the second contact surface is greater than or equal to 50° and less than or equal to 85°, and the maximum cutting depth is greater than or equal to 20 mm.

In an example, the second housing and the third housing are fixed by screws.

In an example, a battery pack for supplying power to the cutting tool is further included, where the rated voltage of the battery pack is greater than or equal to 8 V.

In an example, output power of the electric motor is greater than or equal to 250 W.

In an example, a head adjustment assembly is further included, which is disposed on the first housing and/or the second housing. In the case where the head adjustment assembly is operated, the head assembly is rotatable relative to the trunk assembly.

In an example, a main switch is further included, which is disposed on the first housing. In the case where the head adjustment assembly is operated, the main switch is prevented from being operated.

In an example, a cutting shield and a shield accessory are further included, where the cutting shield covers the cutting piece in a radial direction and is rotatable about the output shaft, the shield accessory is detachably mounted on the cutting shield, and at least one dust suction pipe is detachably mounted on the shield accessory.

In an example, a third contact surface is further included, where in the case where the third contact surface is in contact with the workpiece, the cutting piece has the maximum cutting depth.

In an example, when observed in a plane perpendicular to the output shaft, a projection of the third contact surface on the plane is located between a projection of the first contact surface on the plane and a projection of the second contact surface on the plane.

In an example, a cutting shield is further included, where the cutting shield covers the cutting piece in a radial direction and is rotatable about the output shaft, and the third contact surface is disposed on the cutting shield or the third housing.

In an example, when observed in a plane perpendicular to the output shaft, the first contact surface is tangent to the third contact surface, and the second contact surface is tangent to the third contact surface.

In an example, a projection of the cutting shield in a plane perpendicular to the first axis along the direction of the output shaft has a first shield edge and a second shield edge, the first shield edge is substantially parallel to the first contact surface when the cutting shield is at a first limit position, and the second shield edge is substantially parallel to the second contact surface when the cutting shield is at a second limit position.

In an example, a third contact surface disposed on the third housing is further included, where in the case where the third contact surface is in contact with the workpiece, the cutting piece reaches the maximum cutting depth.

In an example, the third contact surface is configured to be an arc-shaped surface with a fixed radius of curvature greater than or equal to 13 mm.

A handheld tool includes a trunk assembly including at least a first housing for a hand grip; and a head assembly including an electric motor; a second housing configured to accommodate the electric motor; an output shaft to which a cutting piece for cutting a workpiece is mounted; and a transmission assembly accommodated in a third housing, connected between a motor shaft and the output shaft, and configured to transmit a drive force from the electric motor to the output shaft. The handheld tool further includes a cutting shield covering the cutting piece in a radial direction and rotatable about the output shaft relative to the second housing, where the cutting shield is adjustable between a first limit position and a second limit position, which are two limit positions reachable by the cutting shield rotating about the output shaft in opposite directions; the third housing has a first contact surface with the workpiece when the cutting shield is at the first limit position; and the third housing has a second contact surface with the workpiece when the cutting shield is at the second limit position; and a third contact surface disposed on the third housing, where when the third contact surface is in contact with the workpiece, the cutting piece reaches a maximum cutting depth, and the third contact surface is configured to be an arc-shaped surface with a fixed radius of curvature greater than or equal to 13 mm.

In an example, when observed in a plane perpendicular to the output shaft, a projection of the third contact surface on the plane is located between a projection of the first contact surface on the plane and a projection of the second contact surface on the plane.

In an example, when observed in a plane perpendicular to the output shaft, the first contact surface is tangent to the third contact surface, and the second contact surface is tangent to the third contact surface.

In an example, a projection of the cutting shield in a plane perpendicular to the first axis along a direction of the first axis has a first shield edge and a second shield edge, the first shield edge is substantially parallel to the first contact surface when the cutting shield is at the first limit position, and the second shield edge is substantially parallel to the second contact surface when the cutting shield is at the second limit position.

### BRIEF DESCRIPTION OF THE DRAWINGS

FIG. 1 is a schematic view of a cutting tool of the present application.

FIG. 2 is a schematic view of internal structures of the cutting tool in FIG. 1.

FIG. 3 is a top view of the cutting tool in FIG. 1.

FIG. 4 is an exploded view of some structures of a head assembly in FIG. 1.

FIG. 5A is a side view illustrating that a cutting shield in FIG. 1 is adjusted to a first limit position.

FIG. 5B is a side view illustrating that a cutting shield in FIG. 1 is adjusted to an intermediate position.

FIG. 5C is a side view illustrating that a cutting shield in FIG. 1 is adjusted to a second limit position.

FIG. 6 is a side view of some structures in FIG. 1.

FIG. 7 is a partial enlarged view of a head assembly and a cutting shield in FIG. 1.

FIG. 8 is a schematic view of a control assembly in FIG. 1.

FIG. 9 is a schematic view of internal structures of a trunk assembly in FIG. 1.

FIG. 10 is a schematic view of a trunk assembly in FIG. 1 from another angle.

FIG. 11 is a schematic view of the cutting tool in FIG. 1 from another angle.

FIG. 12 is a sectional view illustrating that a dust suction pipe is mounted to a shield accessory in FIG. 11.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term

(such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

The present application provides a cutting tool 100 or a handheld tool, which may specifically be an angle grinder, may be equipped with different grinding discs and cutting discs, and is applicable to the grinding and cutting of different materials such as steel, plastic, wood, and ceramic tiles.

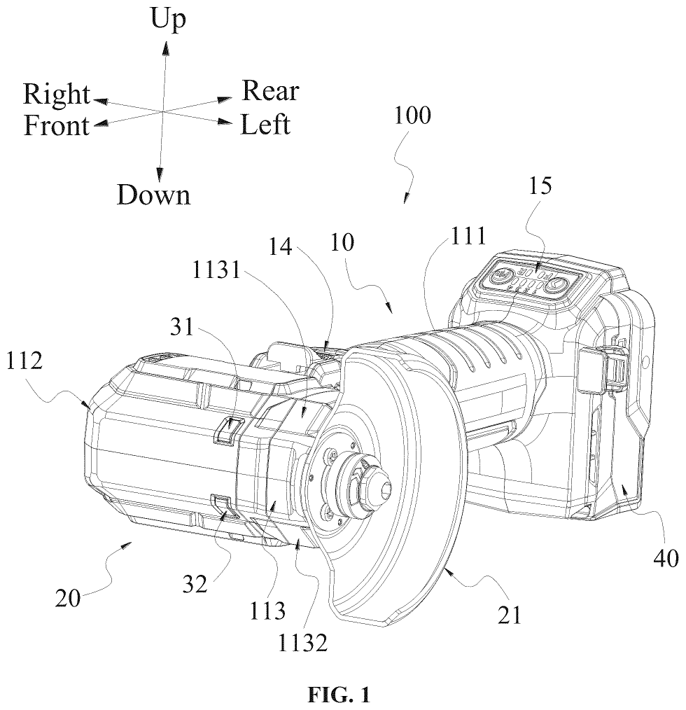

As shown in FIGS. 1 to 3, the cutting tool 100 includes a trunk assembly 10 and a head assembly 20. The trunk assembly 10 includes a first housing 111 for a hand grip. In other words, the first housing 111 is formed with a grip 1111 for a user to hold. The head assembly 20 includes an electric motor 12, a shield 21, a second housing 112, a third housing 113, an output shaft 163, and a transmission assembly 16. The electric motor 12 is accommodated in the second housing 112, and the electric motor 12 includes a motor shaft rotating about a second axis 102. The first housing 111 and the second housing 112 are arranged in sequence from rear to front.

The cutting tool 100 may be powered by a battery pack 40 or mains electricity. In this example, the first housing 111 extends along a front and rear direction of the cutting tool 100, an end of the first housing 111 is connected to the second housing 112, and the other end of the first housing 111 is formed with or connected to a battery pack coupling portion 13 for mounting the battery pack 40.

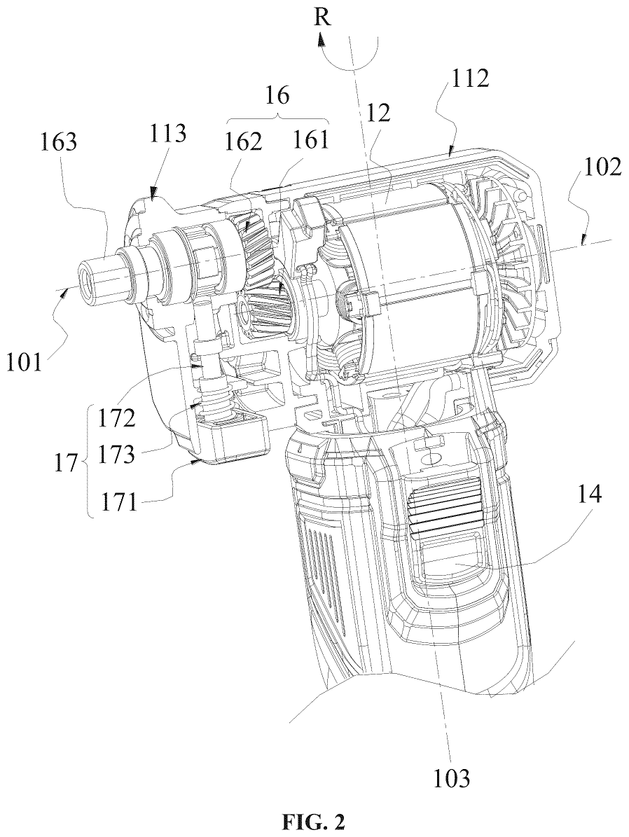

It is to be noted that FIG. 2 is only a schematic view of the transmission assembly 16 of the cutting tool 100, and a housing for accommodating the electric motor 12 and the transmission assembly 16 in FIG. 2 is also illustrative. Specifically, for the first housing 111, the second housing 112, and the third housing 113, reference is made to parts indicated by reference numerals in other drawings than FIG. 2.

The output shaft 163 is used for mounting a cutting piece for cutting a workpiece, where the cutting piece may be a grinding disc, a saw blade, or the like. It is to be understood that the cutting piece is detachable and can be replaced according to actual requirements. The electric motor 12 can drive the cutting piece to rotate about a first axis 101 to perform operation. The output shaft 163 is extending along the first axis 101. In this example, the first axis 101 is substantially parallel to the second axis 102. The distance between the first axis 101 and the second axis 102 may be greater than or equal to 10.5 mm and less than or equal to 15.8 mm. In this example, the distance between the first axis 101 and the second axis 102 is about 13.21 mm.

The transmission assembly 16 is connected between the motor shaft and the output shaft 163 and transmits a drive force from the electric motor 12 to the output shaft 163. In this example, the transmission assembly 16 includes gears which are at least partially disposed in the third housing 113. The transmission assembly 16 includes a driving gear 161 and a driven gear 162, the driving gear 161 is disposed on the motor shaft, the driven gear 162 is disposed on the output shaft 163, and the driving gear 161 meshes with the driven gear 162. The transmission assembly 16 transmits a rotational speed and torque of the electric motor 12 to the output shaft 163, where the rotational speed of the electric motor 12 is reduced and transmitted by the transmission assembly 16 to the output shaft 163.

The third housing 113 accommodates at least part of the transmission assembly 16. In this example, the transmission assembly 16 is more accommodated in the third housing 113 than the second housing 112. That is to say, a part of the transmission assembly 16 is accommodated in the second housing 112 and the other part of the transmission assembly 16 is accommodated in the third housing 113. The second housing 112 and the third housing 113 are combined into a whole in which structures such as the electric motor 12 and the transmission assembly 16 of the cutting tool 100 are accommodated. When the cutting tool 100 performs cutting, the third housing 113 is in direct contact with the workpiece to form a contact surface. A whole formed by the first housing 111, the second housing 112, and the third housing 113 is referred to as a body housing 11. In the present application, the “workpiece” refers to a workpiece cut by the cutting tool 100. A cutting shield 21 is mounted to the third housing 113. When the cutting tool 100 performs cutting, the cutting shield 21 shields at least part of the cutting piece so that debris generated by the cutting piece during cutting can be blocked by the cutting shield 21. The cutting shield 21 covers the cutting piece in a radial direction and is rotatable about the output shaft 163. The cutting shield 21 can rotate about the first axis 101 relative to the body housing 11 so that a position of the cutting shield 21 can be adjusted as required, and the cutting shield 21 can well block the debris.

The cutting tool 100 further includes a main switch 14 and a circuit board, where the main switch 14 is configured to control the electric motor 12 to start or stop. In an example, the circuit board is disposed in the first housing 111, the electric motor 12 is connected to the circuit board through the main switch 14, and the battery pack 40 can supply power to the circuit board.

As shown in FIG. 2, the head assembly 20 includes the transmission assembly 16, and the center distance between the driving gear 161 and the driven gear 162 of the transmission assembly is greater than or equal to 11 mm and less than or equal to 15 mm. In an example, the center distance between the driving gear 161 and the driven gear 162 may be 12 mm, 13 mm, or 14 mm. The pitch diameter of the driving gear 161 is about 15.16 mm, and the pitch diameter of the driven gear 162 is about 10.37 mm. The gear ratio formed by the driving gear 161 and the driven gear 162 is 19:13. In this manner, the gear structure of the transmission assembly 16 forms a relatively small region on a plane perpendicular to the motor shaft so that the transmission assembly 16 can be accommodated within a range of the inner diameter of the second housing 112. A boundary of the third housing 113 and a boundary of the second housing 112 in a forward direction are basically flush, and the third housing 113 does not protrude relative to the second housing 112 so that the whole machine has relatively coordinated proportions, and the head assembly 20 is small in volume. A maximum outer diameter T of the head assembly 20 is less than or equal to 55 mm. In some examples, the maximum outer diameter T of the head assembly 20 may be 48 mm, 50 mm, 52 mm, or 54 mm.

The head assembly 20 further includes a shaft lock structure 17, and the shaft lock structure 17 includes a shaft lock button 171, a shaft lock rod 172, and a first elastic member 173. When the shaft lock button 171 is pushed upward, the first elastic member 173 is compressed, and the shaft lock rod 172 is inserted upward into a slot of the output shaft 163 so that the output shaft 163 cannot rotate. When the shaft lock button 171 is pressed again, the first elastic member 173 is restored, and the shaft lock rod 172 is ejected out of the slot of the output shaft 163.

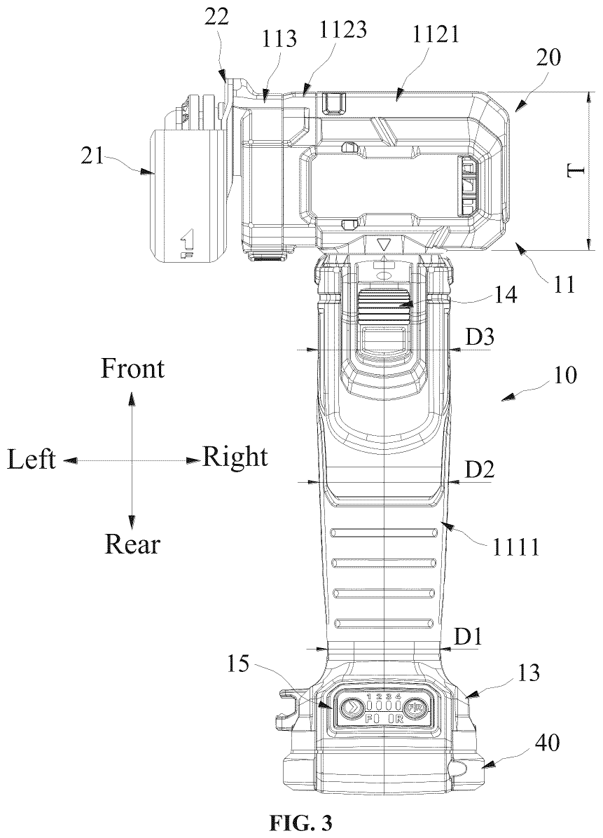

As shown in FIG. 3, the grip 1111 of the trunk assembly 10 extends from the second housing 112 to the battery pack coupling portion 13. The grip 1111 has multiple different outer diameters. The grip 1111 has a minimum first outer diameter D1 at a transition and coupling position between the grip 1111 and the battery pack coupling portion 13, where the first outer diameter D1 is less than or equal to 40 mm. In some examples, the first outer diameter D1 may be 35 mm, 36 mm, 37 mm, 38 mm, or 39 mm. In this example, a region where the first outer diameter D1 is located is a farthest portion of a region that the user can grip. The grip 1111 has a second outer diameter D2 at a midpoint of the grip 1111 in the front and rear direction, where the second outer diameter D2 is located at the geometric center of the whole grip region in the front and rear direction. The second outer diameter D2 may be about 41 mm, 43 mm, or 45 mm. In this example, a grip region outside the main switch 14 is a portion of the grip 1111 having a maximum outer diameter. The grip region outside the main switch 14 has a third outer diameter D3, where the third outer diameter D3 is less than or equal to 50 mm. In some examples, the third outer diameter D3 is about 42 mm, 44 mm, 46 mm, or 48 mm.

The ratio of the maximum outer diameter T of the head assembly 20 to the second outer diameter D2 of the grip 1111 is greater than or equal to 1.05 and less than or equal to 1.37. In an example, the ratio of the maximum outer diameter T to the second outer diameter D2 is greater than or equal to 1.1 and less than or equal to 1.3. In some examples, the ratio of the maximum outer diameter T to the second outer diameter D2 is about 1.19.

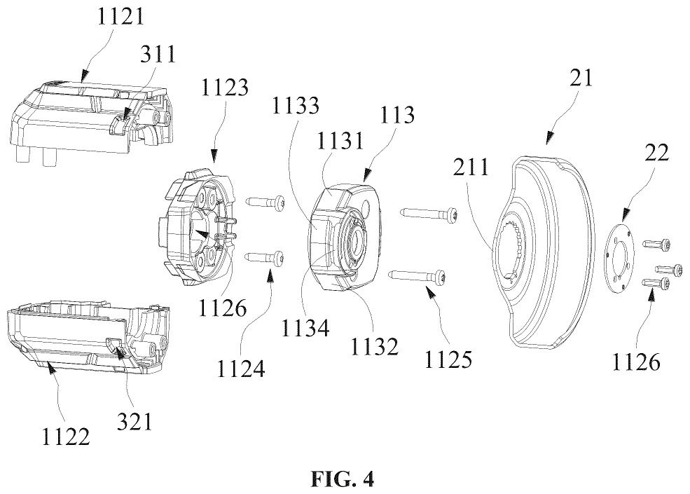

As shown in FIG. 4, the second housing 112 includes an upper housing 1121 and a lower housing 1122, and the upper housing 1121 and the lower housing 1122 are inserted together. The second housing 112 further includes a side housing 1123. When the upper housing 1121 and the lower housing 1122 are combined together, the side housing 1123 is mounted on the same side of the upper housing 1121 and the lower housing 1122, which is the left side in this example. First screws 1124 are used to fix the side housing 1123 to the upper housing 1121 and the lower housing 1122. In this example, two first screws 1124 are provided. The driving gear 161 is accommodated in the side housing 1123. In some examples, an output end of the motor shaft of the electric motor 12 may extend to the inside of the side housing 1123.

The third housing 113 is located on the left side of the side housing 1123. That is to say, the third housing 113 is located between the cutting shield 21 and the side housing 1123. The third housing 113 accommodates at least part of the transmission assembly 16. The third housing 113 and the second housing 112 are fixed by screws. Second screws 1125 for the third housing 113 penetrate through the side housing 1123 and extend into the upper housing 1121 and the lower housing 1122, so as to achieve sealing. In this example, two second screws 1125 are provided. A washer 22 is provided on the left side of the cutting shield 21, and third screws 1126 penetrate through the washer 22 to rotatably fix the cutting shield 21 to the third housing 113. In this example, three third screws 1126 are provided.

In this example, the third housing 113 and the side housing 1123 are made of the same material, an aluminum alloy. The upper housing 1121 and the lower housing 1122 are made of the same material, plastic. The transmission assembly 16 is accommodated in an accommodation space jointly formed by the third housing 113 and the side housing 1123. During cutting, the third housing 113 may be in contact with the workpiece. In an example, the side housing 1123 may be made of the same material as the upper housing 1121 and the lower housing 1122. Materials of the housings are not limited.

Connections between the side housing 1123 and the upper housing 1121 and the lower housing 1122 and connections between the third housing 113 and the side housing 1123 are designed to be hidden, that is, no screws exist on circumferential exterior surfaces of the housings along the second axis 102, so that the second housing 112 and the third housing 113 have complete cylindrical surfaces and no screws are visible from the outside, achieving a better visual effect, a simple structure, and a small volume. When the head assembly 20 is rotated about a third straight line 103, the cutting can still be performed regardless of positions of the screws.

As shown in FIGS. 4 and 1, the cutting tool 100 further includes a lighting assembly 30, and the lighting assembly 30 includes a first lighting member 31 and a second lighting member 32 disposed up and down. The first lighting member 31 is disposed in the upper housing 1121, the upper housing 1121 includes a first opening 311, and light of the first lighting member 31 is transmitted through the first opening 311. The second lighting member 32 is disposed in the lower housing 1122, the lower housing 1122 includes a second opening 321, and light of the second lighting member 32 is transmitted through the second opening 321. The first lighting member 31 and the second lighting member 32 are symmetrical about a parting plane between the upper housing 1121 and the lower housing 1122. In this manner, the lighting during operation of the cutting tool 100 can be compatible with left and right hands, and an operation region can be illuminated regardless of an operation posture.

When the main switch 14 is operated to power on the cutting tool 100, the rotation of the electric motor 12 powers on the circuit board, and the lighting assembly 30 is turned on. When the main switch 14 is operated to shut down the cutting tool 100, the lighting assembly 30 is extinguished after a period of time since the cutting piece stops rotating.

As shown in FIG. 4, the third housing 113 has a first contact surface 1131 and a second contact surface 1132. A transition surface 1133 is also formed between the first contact surface 1131 and the second contact surface 1132, and the transition surface 1133 is connected to the first contact surface 1131 and the second contact surface 1132. When the user cuts the workpiece, the first contact surface 1131 or the second contact surface 1132 gradually approaches the workpiece and eventually is in contact with the workpiece in a process of the cutting piece gradually deepening into the workpiece. When the first contact surface 1131 or the second contact surface 1132 is in contact with a surface of the workpiece being cut, the cutting tool 100 reaches a maximum cutting depth. In this example, due to a dimension of the transition surface 1133 relative to the first contact surface 1131 and the second contact surface 1132, the transition surface 1133 is not in contact with the workpiece during cutting.

In this example, the first contact surface 1131 and the second contact surface 1132 are substantially planar. In other possible examples, the first contact surface 1131 may be configured to be formed by at least one contact point, for example, the top of a raised structure may form the first contact surface 1131. When the workpiece is in point contact with the cutting tool 100, at least two contact points collectively form a contact plane, which may be understood as the first contact surface 1131 in this example. Similarly, the second contact surface 1132 may be defined in the same manners.

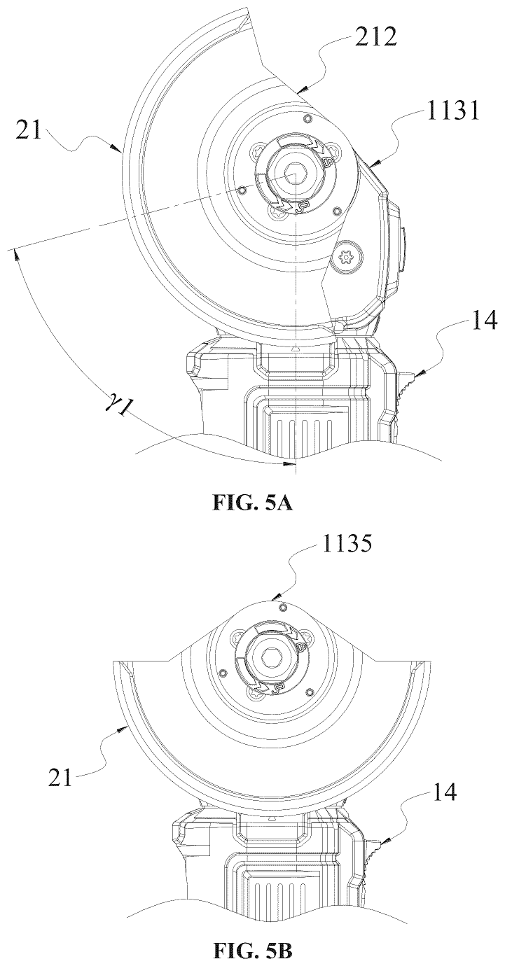

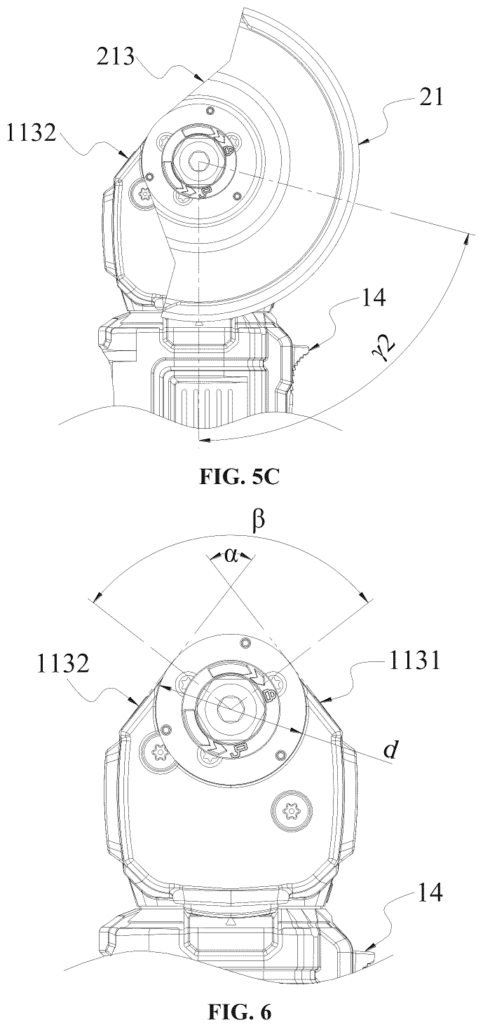

FIGS. 5A to 5C show schematic views when the cutting shield 21 is rotated to different positions. In this example, the cutting shield 21 is rotatable relative to the body housing 11. The cutting shield 21 is adjustable between a first limit position and a second limit position, which are two limit positions reachable by the cutting shield 21 rotating about the output shaft 163 in opposite directions. The third housing 113 has the first contact surface 1131 with the workpiece when the cutting shield 21 is at the first limit position; and the third housing 113 has the second contact surface 1132 with the workpiece when the cutting shield 21 is at the second limit position.

FIG. 5A is a schematic view when the cutting shield 21 is rotated to the first limit position. When the cutting shield 21 is at the first limit position, the cutting tool 100 may cut the workpiece mainly located on the upper side of the cutting tool 100. FIGS. 5B and 1 are schematic views when the cutting shield 21 is rotated to an intermediate position. When the cutting shield 21 is at the intermediate position, the cutting tool 100 may cut the workpiece mainly located on the front side of the cutting tool 100. FIG. 5C is a schematic view when the cutting shield 21 is rotated to the second limit position. When the cutting shield 21 is at the second limit position, the cutting tool 100 may cut the workpiece mainly located on the lower side of the cutting tool 100. When the cutting shield 21 is adjusted between the first limit position and the second limit position, the user can cut the workpiece in all directions by rotating the angle of a hand relative to the workpiece.

When observed from the left side of the cutting tool 100, the cutting shield 21 may be rotated clockwise by a first angle γ1 from the intermediate position to the first limit position or may be rotated counterclockwise by a second angle γ2 from the intermediate position to the second limit position. In this example, the first angle γ1 is 75°, and the second angle γ2 is also 75°. The first angle γ1 may be the same as or different from the second angle γ2. In an example, the first angle γ1 and the second angle γ2 are both 60°. In an example, the first angle γ1 and the second angle γ2 are both 70°. Due to the relatively large first angle γ1 and second angle γ2, the user can perform cutting when the cutting shield 21 is rotated within a relatively large range, facilitating the operation of the user. As shown in FIG. 5A, the cutting shield 21 is rotated to the first limit position and the cutting is performed, and when the first contact surface 1131 is in contact with the workpiece, the cutting tool 100 reaches the maximum cutting depth. As shown in FIG. 5B, the cutting shield 21 is rotated to a second cutting position and the cutting is performed, and when a shield end surface 211 and a washer end surface 221 gradually approach the workpiece and eventually are in contact with the workpiece, the cutting piece performs cutting to a deepest position. In this example, since the shield end surface 211 and the washer end surface 221 are each part of a circle, the workpiece may be in contact with any position of the shield end surface 211 and the washer end surface 221. As shown in FIG. 5C, the cutting shield 21 is rotated to the second limit position and the cutting is performed, and when the second contact surface 1132 is in contact with the workpiece, the cutting tool 100 reaches the maximum cutting depth.

As shown in FIGS. 5A and 5C, a projection of the cutting shield 21 into a plane perpendicular to the first axis 101 along a direction of the first axis 101 has a first shield edge 212 and a second shield edge 213. The first shield edge 212 is substantially parallel to the first contact surface 1131 when the cutting shield 21 is at the first limit position, and the second shield edge 213 is substantially parallel to the second contact surface 1132 when the cutting shield is at the second limit position.

That is to say, in a process of the cutting piece cutting the workpiece, the third housing 113 has the first contact surface 1131 and the second contact surface 1132 with the workpiece; and in the case where the first contact surface 1131 or the second contact surface 1132 is in contact with the workpiece, the cutting piece reaches the maximum cutting depth.

Referring to FIGS. 4 to 7, the cutting shield 21 has the shield end surface 211 disposed on the most front side of the cutting shield 21 shown in FIG. 1. In this example, when the cutting piece performs cutting to the maximum depth, the shield end surface 211 of the cutting shield 21 is in contact with the workpiece.

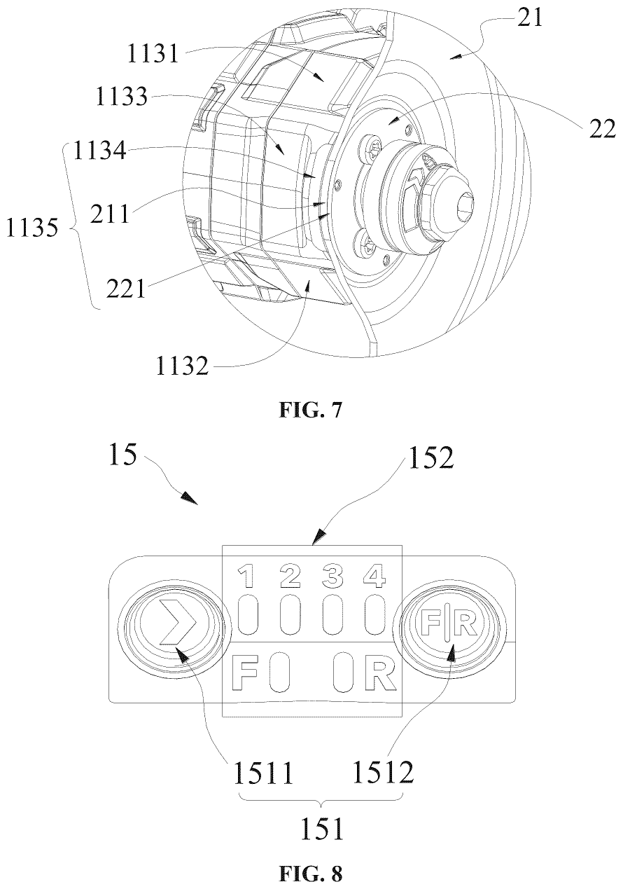

As shown in FIG. 7, in this example, the washer 22 is circular, and the radius of the washer 22 is the same as the distance from the center of rotation of the cutting shield 21 to the shield end surface 211. When the washer 22 is mounted to the cutting shield 21, a portion of the washer 22 on the most front side, as shown in FIG. 1, is the washer end surface 221. When observed in a left and right direction of the cutting tool 100, at least part of an outer contour of the washer 22 substantially coincides with an outer contour of the cutting shield 21. In this example, the washer end surface 221 substantially coincides with the shield end surface 211. In this example, when the cutting piece performs cutting to the maximum depth, the shield end surface 211 and the washer end surface 221 are both in contact with the workpiece.

The third housing 113 further includes a housing end surface 1134, the housing end surface is formed by an arc-shaped surface, and the housing end surface 1134 is an end surface of the third housing 113 closest to the front. That is to say, when the third housing 113 is mounted to the second housing 112, the arc-shaped surface of the third housing 113 on the most front side, as shown in FIG. 1, is the housing end surface 1134. Assuming that the workpiece is placed directly in front of the cutting tool 100, that is, the cutting shield 21 is adjusted to the position shown in FIG. 5B and the cutting is performed, the housing end surface 1134 is a surface of the third housing 113 closest to the workpiece.

Along a direction of the first axis 101, the cutting tool 100 has the washer end surface 221, the shield end surface 211, and the housing end surface 1134 in sequence from left to right. A third contact surface 1135 is defined as at least one of the washer end surface 221, the shield end surface 211, or the housing end surface 1134, and when the third contact surface 1135 is in contact with the workpiece, the cutting tool 100 can reach the maximum cutting depth. The third contact surface 1135 is located between the first contact surface 1131 and the second contact surface 1132. “Between” here means that when observed in a plane perpendicular to the first axis 101, a projection of the third contact surface 1135 on the plane is located between a projection of the first contact surface 1131 on the plane and a projection of the second contact surface 1132 on the plane.

The third contact surface 1135 is configured to be the arc-shaped surface with a fixed radius of curvature, and the radius of curvature of the arc-shaped surface is greater than or equal to 13 mm. In some examples, the radius of curvature of the third contact surface 1135 may be 14 mm, 15 mm, 16 mm, 17 mm, 18 mm, 19 mm, or 20 mm. With a saw blade having a diameter of 76 mm mounted as an example, when the radius of curvature of the third contact surface 1135 is 16 mm, the maximum cutting depth is 22 mm. When observed in the plane perpendicular to the output shaft, the first contact surface 1131 is tangent to the third contact surface 1135, and the second contact surface 1132 is tangent to the third contact surface 1135 (see FIGS. 5B and 6). In this manner, when the cutting shield 21 of the cutting tool 100 is rotated to any angle and the user pushes the cutting tool 100 to a deepest position of the workpiece, the same maximum cutting depth is achieved. That is to say, when the user uses the cutting tool 100, the user can operate the cutting disc to the deepest position without adjusting the cutting tool 100 to a certain angle, greatly improving the user experience.

In an example, when the cutting shield 21 is located at the intermediate position shown in FIG. 5B, the housing end surface 1134 may be in contact with the workpiece so that the cutting piece performs cutting to the maximum depth. That is to say, the third contact surface 1135 includes the housing end surface 1134, and the shield end surface 211, the washer end surface 221, and the housing end surface 1134 may touch the workpiece at the same time, and the cutting tool 100 reaches the maximum cutting depth.

In an example, the third contact surface 1135 includes only the shield end surface 211 and the washer end surface 221, and the housing end surface 1134 cannot be in contact with the workpiece. In this example, the housing end surface 1134 is slightly lower than the shield end surface 211 and the washer end surface 221 due to manufacturing and mounting errors.

It is to be noted that in the case where the cutting shield 21 is at the two limit positions, other contact surfaces may exist in addition to the first contact surface 1131 and the second contact surface 1132, but the cutting tool 100 has the maximum cutting depth only when the first contact surface 1131 and the second contact surface 1132 are in contact with the workpiece.

As shown in FIG. 6, a first angle α is formed between the first contact surface 1131 and the second contact surface 1132, where the first angle α is greater than or equal to 50° and less than or equal to 85°. In an example, the first angle α is greater than or equal to 60° and less than or equal to 85°. In some examples, the first angle α may be 73°, 75°, 78°, 80°, 82°, or the like. A cutting angle β of the cutting tool 100 is complementary to the first angle α, and therefore, the cutting angle β is greater than or equal to 90° and less than or equal to 120°. In some examples, the cutting angle β may be 98°, 100°, 102°, 105°, 107°, or the like. When the cutting angle β is within the above range, the maximum cutting depth of the cutting tool 100 is 22 mm. In some examples, the maximum cutting depth of the cutting tool 100 may be 20 mm, 21 mm, 22 mm, 23 mm, or 24 mm.

The rated voltage of the battery pack 40 is greater than or equal to 8 V and less than or equal to 36 V. In some examples, the rated voltage of the battery pack 40 may be 12 V, 16 V, 20 V, 24 V, or the like. Maximum output power of the battery pack 40 is greater than or equal to 250 W and less than or equal to 600 W. In some examples, the maximum output power of the battery pack 40 may be 300 W, 320 W, 340 W, 380 W, 400 W, 450 W, or the like.

The overall weight of the cutting tool 100 refers to a total weight of the cutting tool 100 with the battery pack 40 mounted, where the overall weight of the cutting tool 100 is greater than or equal to 1000 g. In some examples, the overall weight of the cutting tool 100 may be 1100 g, 1200 g, or 1300 g. The bare tool weight of the cutting tool 100 refers to a weight excluding only the battery pack 40, where the bare tool weight of the cutting tool 100 is greater than or equal to 700 g. In some examples, the bare tool weight of the cutting tool 100 may be 750 g, 800 g, or 850 g.

The power-to-mass ratio of the cutting tool 100 is defined as the ratio of output power of the battery pack 40 to the mass of the whole machine. The power-to-mass ratio is greater than or equal to 0.22 and less than or equal to 0.35. In some examples, the power-to-mass ratio is about 0.24, 0.26, 0.28, or 0.3. Output power of the electric motor 12 is greater than or equal to 200 W. In an example, the output power of the electric motor 12 is greater than or equal to 250 W. In some examples, the output power of the electric motor 12 may be 280 W, 300 W, or 330 W.

As shown in FIGS. 3 and 8, a control assembly 15 is provided on a top housing of the battery pack coupling portion 13, and the control assembly 15 is a communication channel between the user and the cutting tool 100. The user controls, through the control assembly 15, parts that can be controlled by the user, such as the electric motor 12 and the cutting piece. The control assembly 15 includes a control portion 151 and a display portion 152. The control portion 151 includes a first control key 1511 and a second control key 1512, the first control key 1511 is used for adjusting the rotational speed of the electric motor 12, and the second control key 1512 is used for switching the output shaft 163 between forward rotation and reverse rotation. The display portion 152 is configured to display a rotational speed gear and forward or reverse rotation information of the cutting tool 100.

Four light-emitting diode (LED) lamp beads matched with numbers “1”, “2”, “3”, and “4” respectively are provided in the first row of the display portion 152, and two LED lamp beads matched with letters “F” and “R” respectively are provided in the second row of the display portion 152. A number in the first row represents the rotational speed gear of the cutting tool 100, and a letter in the second row represents a forward rotation mode or a reverse rotation mode of the cutting tool 100. The first control key 1511 is provided with an arrow, and the first control key 1511 is pressed to increase or decrease the rotational speed of the electric motor 12 via shifting. For example, when the first control key 1511 is pressed for the first time, the rotational speed gear is 1. After the first control key 1511 is released and pressed for the second time, the rotational speed gear is increased to 2. Starting from 1, the rotational speed gear is increased by one gear every time the first control key 1511 is pressed until the rotational speed gear is increased to 4. After the rotational speed gear is increased to 4, the rotational speed gear is decreased by one gear every time the first control key 1511 is pressed until the rotational speed gear is decreased to 1. Every time the rotational speed gear is switched to one gear, the corresponding LED light is on.

The second control key 1512 is disposed on the other side of the display portion 152 opposite to the first control key 1511, and the second control key 1512 is marked with letters “F/R”. When the second control key 1512 is pressed for the first time, the cutting tool 100 is in the forward rotation, and an LED light closest to the letter “F” in the second row of the display portion 152 is on. When the second control key 1512 is pressed for the second time, the cutting tool 100 is adjusted to the reverse rotation, and an LED light closest to the letter “R” in the second row of the display portion 152 is on. The second control key 1512 is pressed to switch the cutting tool 100 cyclically, and the LED light is on for display. It is to be noted that indicator lights of the display portion 152 are not necessarily LED lights and may be other forms of prompts, which are not limited here. The forward rotation and the reverse rotation may be represented by other letters or icons different from “F” and “R”, which are not limited here.

In this manner, the control assembly 15 of the cutting tool 100 is disposed at the foot, and speed regulation and direction change functions are integrated on the same interface, which is conducive to reducing the overall size of an operation panel, reducing a space occupied by the operation panel on the body, and facilitating the control of the user.

In an example, after the second control key 1512 is operated to set a rotational direction, the circuit board memorizes the current rotational direction. When the cutting tool 100 is powered on after the cutting tool 100 is powered off or the battery pack 40 is removed and inserted again, the rotational direction before the last power-off can be maintained.

In an example, after the second control key 1512 is operated to set the rotational direction, the cutting tool 100 rotates in a first rotational direction. After the cutting tool 100 shuts down, a time from the shutdown to the next power-on is a waiting time. When the waiting time is shorter than a preset shutdown time period, it is set that the cutting tool 100 still operates in the first rotational direction when the cutting tool 100 is powered on after the shutdown. When the waiting time is longer than the preset shutdown time period, it is set that the cutting tool 100 operates in the forward rotation mode when the cutting tool 100 is powered on after the shutdown. The preset shutdown time period may be less than or equal to 30 min. In some examples, the preset shutdown time period may be 5 min, 10 min, 15 min, 20 min, or 25 min. For example, the user operates the second control key 1512 to set the first rotational direction to the reverse rotation, and the preset shutdown time period is 10 min. After the cutting tool 100 is in operation for a period of time, the user leaves briefly and shuts down the cutting tool 100 for 5 min. When the user returns to continue cutting after the power-on, since an actual shutdown time period is shorter than the preset shutdown time period, the cutting tool 100 is still in a reverse rotation state after the power-on.

In another example, the second control key 1512 has a long press function and a short press function, the long press function enables the cutting tool 100 to switch to a memory mode or a reset mode, and the short press function of the second control key 1512 enables the rotational direction to be switched normally. The memory mode refers to that the cutting tool 100 remains in the current rotational direction after the shutdown and power-off or after the battery pack 40 is replaced. The reset mode refers to that the cutting tool 100 automatically resets to the forward rotation after the shutdown and power-off or after the battery pack 40 is replaced. During initial use, the cutting tool 100 is in the reset mode. A long press on the second control key 1512 makes the cutting tool 100 switch to the memory mode. A second long press on the second control key 1512 makes the cutting tool 100 switch back to the reset mode, and so on. The long press function may be continuously pressing the second control key 1512 for 3 s to 5 s or may be operating the second control key 1512 for a significantly longer time than the short press function.

As shown in FIGS. 2, 9, and 10, the head assembly 20 of the cutting tool 100 is rotatable about the trunk assembly 10. As shown in FIG. 2, the trunk assembly 10 extends along the third straight line 103, and the head assembly 20 is rotatable about the third straight line 103. In this example, the head assembly 20 is rotated clockwise, referring to a first direction R in FIG. 2.

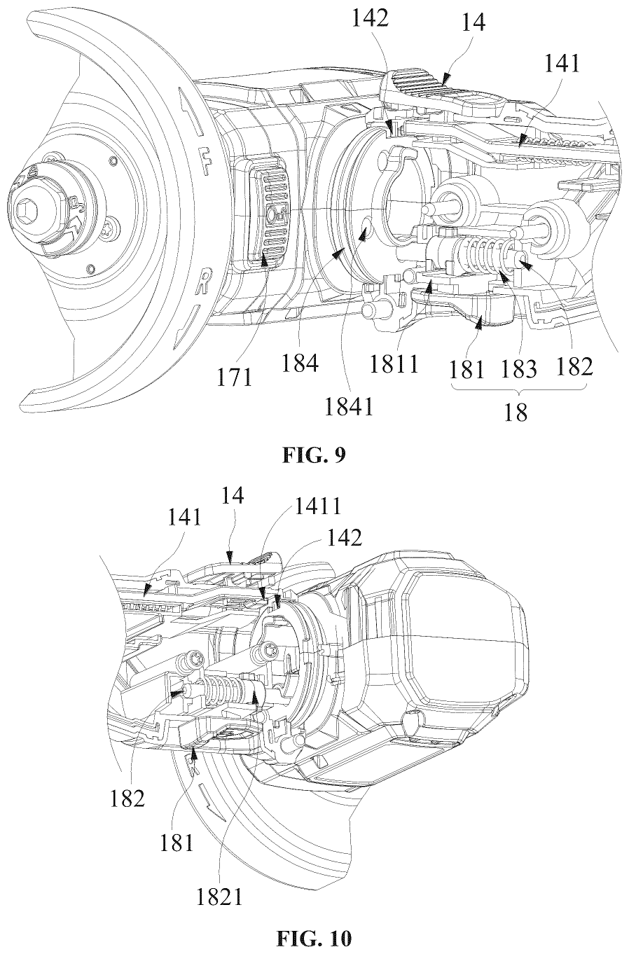

FIGS. 9 and 10 further disclose the working principle of rotation of the head assembly 20 relative to the trunk assembly 10. The cutting tool 100 is provided with a head adjustment assembly 18 disposed on the first housing 111 and/or the second housing 112, and the head assembly 20 is rotatable relative to the trunk assembly 10 in the case where the head adjustment assembly 18 is operated.

The head adjustment assembly 18 includes an adjustment switch 181, a locking pin 182, and a second elastic member 183. When the user desires to rotate the head assembly 20, the user needs to operate the adjustment switch 181, and the locking pin 182 is driven by the adjustment switch 181 to be withdrawn from the inside of the housing of the head assembly 20 so that the head assembly 20 is unlocked. When the head assembly 20 is rotated to a desired angle, the adjustment switch 181 is adjusted so that the locking pin 182 enters the housing of the head assembly 20 to lock the head assembly 20. In this example, FIG. 1 discloses a position of the head assembly 20 that is not rotated or rotated to 0°, and the head assembly 20 may be rotated by 90° or 180°. In other examples, the head assembly 20 may be configured to rotate by different angles.

The adjustment switch 181 is provided with a drive portion 1811, and the drive portion 1811 may drive the locking pin 182 to move along an extension direction of the locking pin 182. The locking pin 182 is provided with a positioning member 1821, and the positioning member 1821 mates with the drive portion 1811 through contact. In an example, the drive portion 1811 may push the positioning member 1821 along a direction substantially parallel to the drive portion 1811 to drive the locking pin 182 to move. In another example, the positioning member 1821 may pass through the drive portion 1811 along a direction not parallel to a direction of movement of the drive portion 1811, to drive the locking pin 182 to move.

The head assembly 20 further includes a rotating track 184, and the head assembly 20 and the trunk assembly 10 can rotate relatively on the rotating track 184. In other words, the relative rotation between the first housing 111 and the second housing 112 is generated on the rotating track 184. The rotating track 184 may be disposed at the most front end of the first housing 111 or at the rear-most end of the second housing 112 or may connect the first housing 111 to the second housing 112 as a separate component. The rotating track 184 includes at least one recessed track, and the rotating track 184 is circumferentially distributed. In this example, the rotating track 184 is formed by the second housing 112, and correspondingly, a slide track that can mate with the rotating track 184 is formed on the first housing 111 so that the first housing 111 and the second housing 112 can move relatively.

The housing of the rotating track 184 is formed with multiple locking holes 1841, and the locking pin 182 can be inserted into each locking hole 1841. The second elastic member 183 is disposed on the rear side of the positioning member 1821. When the locking pin 182 is in a locked state, the second elastic member 183 is compressed, ensuring that the locking pin 182 is pushed into the locking hole 1841 and does not fall out. When the locking pin 182 is unlocked, the second elastic member 183 is further compressed. The hand of the user provides a force for compressing the second elastic member 183 so that the adjustment switch 181 is not accidentally operated.

The internal structure of the main switch 14 is also disclosed in views of FIGS. 9 and 10. The main switch 14 is disposed on the first housing 111. In the case where the head adjustment assembly 18 is operated, the main switch 14 is prevented from being operated. A switch pull rod 141 is connected to the lower end of the main switch 14, a boss 1411 is formed at the most front end of the switch pull rod 141, and the rotating track 184 is formed with a groove 142 for the boss 1411 to be inserted into. When the head assembly 20 is at a lockable angle relative to the trunk assembly 10, the main switch 14 is pushed forward, and the switch pull rod 141 can be inserted into the groove 142. It is to be noted that only after the locking pin 182 is locked at a correct position, can the boss 1411 on the switch pull rod 141 be clamped into the groove 142, and can the main switch 14 be activated normally. If the locking pin 182 is at an abnormal position, the boss 1411 abuts against a rib surface so that the main switch 14 cannot be pushed, and the machine cannot be started.

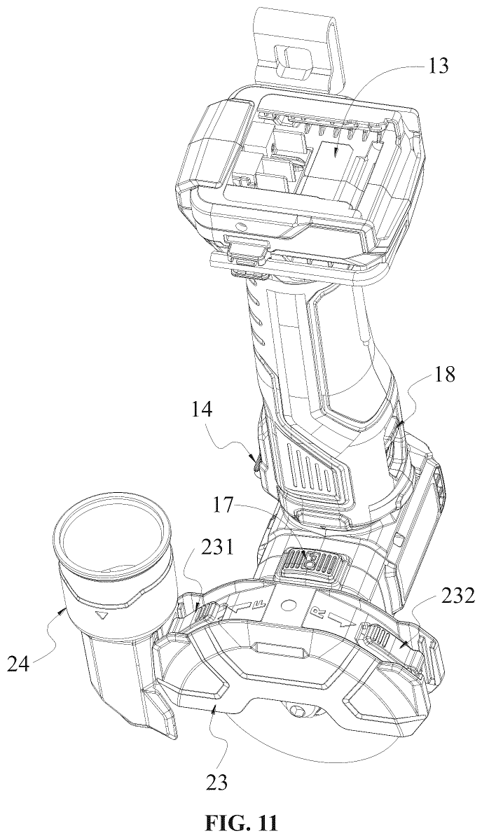

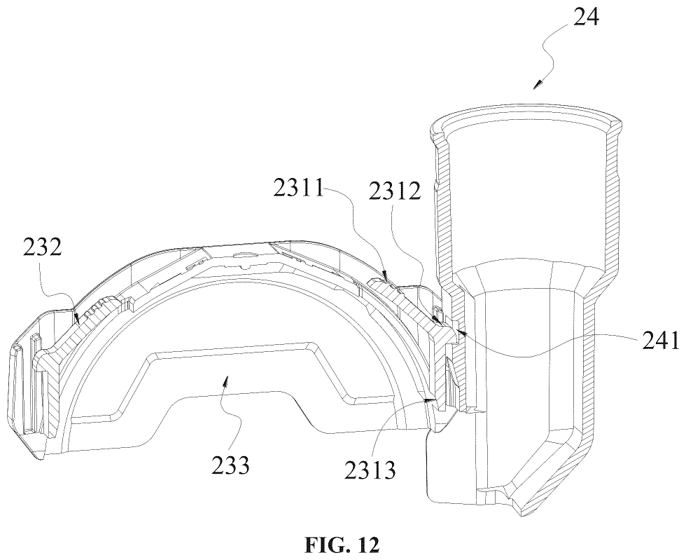

As shown in FIGS. 11 and 12, the cutting tool 100 further includes a shield accessory 23 detachably mounted on the cutting shield 21. In this example, the shield accessory 23 is sleeved on the cutting shield 21, and at least one dust suction pipe 24 is detachably mounted on the shield accessory 23. In this example, dust suction pipes 24 may be connected to two ends of the shield accessory 23. A cutting direction of the cutting tool 100 can rotate along the first direction R. That is to say, the shield 21 and the shield accessory 23 mating with the shield 21 may be located on the left side or right side of the grip 1111. Therefore, a mounting position of the dust suction pipe 24 may be selected according to the cutting direction and the rotational direction of the saw blade, so as to adapt to requirements in different operating conditions.

The shield accessory 23 is provided with a first operating member 231 and a second operating member 232 opposite to each other, and the first operating member 231 and the second operating member 232 can be separately used for locking and unlocking the dust suction pipe 24. The shield accessory 23 further includes a shield accessory housing 233, and the first operating member 231 and the second operating member 232 are both mounted or connected to the shield accessory housing 233.

The first operating member 231 includes a trigger portion 2311, a limiting portion 2312, and a connecting portion 2313, and the trigger portion 2311 is disposed at an end of the first operating member 231 and operated by the user. The connecting portion 2313 is disposed at the other end opposite to the trigger portion, and the first operating member 231 is connected to the shield accessory housing 233 through the connecting portion 2313. In this example, the first operating member 231 and the shield accessory housing 233 are integrally formed. In other examples, the first operating member 231 and the shield accessory housing 233 may be separately formed and connected together. The limiting portion 2312 is disposed substantially on an intermediate portion of the first operating member 231, and the first operating member 231 is substantially tick-shaped.

A mating portion 241 is formed on the outer wall of the dust suction pipe 24, and the mating portion 241 is a groove that is not through the outer wall. When the user presses the trigger portion 2311, the limiting portion 2312 is disengaged from the mating portion 241 of the dust suction pipe 24 so that the dust suction pipe 24 is allowed to slide up and down to be detached from the shield accessory 23. In a natural state, due to an elastic force of a material of the first operating member 231, the limiting portion 2312 is clamped into the mating portion 241 of the dust suction pipe 24. When the user presses the trigger portion 2311, the first operating member 231 deforms elastically, and the limiting portion 2312 is disengaged from the mating portion 241. In this example, the shield accessory 23 is made of a plastic material.

Generally, angle grinders may be divided into a conventional angle grinder and a mini angle grinder, where a grinding disc of the conventional angle grinder has a greater diameter than that of the mini angle grinder and can reach a larger cutting depth and a wider cutting angle. The diameter of the grinding disc of the conventional angle grinder is greater than or equal to 100 mm, while the diameter of the grinding disc of the mini angle grinder is less than 100 mm. Due to a relatively large volume, the conventional angle grinder has enough space to set a relatively large cutting depth and cutting angle. The technical solutions involved in the present application enable the mini angle grinder to have a relatively large cutting depth and cutting angle, and when the cutting shield 21 is rotated to any adjustable position, the user can perform cutting to the maximum cutting depth. In this example, the cutting tool 100 is a mini angle grinder matched with a grinding disc or cutting disc having a diameter of 76 mm.

In an example, the diameter of the cutting piece of the cutting tool 100 is greater than 60 mm and less than 100 mm. In an example, the diameter of the cutting piece of the cutting tool 100 is greater than 60 mm and less than 90 mm. In an example, the diameter of the cutting piece of the cutting tool 100 is greater than 60 mm and less than 85 mm. In this example, the cutting tool 100 is mounted with the grinding disc or cutting disc having a diameter of 76 mm as the cutting piece.

It is to be noted that the technical solutions disclosed in the specification are applicable to the handheld tool or the angle grinder in addition to the cutting tool 100.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A cutting tool, comprising:
a trunk assembly comprising at least a first housing for a hand grip;
a head assembly comprising an electric motor coupled to a motor shaft; a second housing configured to accommodate the electric motor; an output shaft to which a cutting piece for cutting a workpiece is mounted and extending along a first axis; and a transmission assembly connected between the motor shaft and the output shaft and configured to transmit a drive force from the electric motor to the output shaft; and
a third housing for accommodating at least part of the transmission assembly having a first contact surface and a second contact surface wherein, when the first contact surface or the second contact surface is in contact with the workpiece, the cutting piece has a maximum cutting depth that is greater than or equal to 20 mm and an angle between the first contact surface and the second contact surface is greater than or equal to 50° and less than or equal to 85°.

2. The cutting tool according to claim 1, wherein the second housing and the third housing are fixed by screws.

3. The cutting tool according to claim 1, further comprising a battery pack for supplying power to the cutting tool, wherein a rated voltage of the battery pack is greater than or equal to 8 V.

4. The cutting tool according to claim 1, wherein an output power of the electric motor is greater than or equal to 250 W.

5. The cutting tool according to claim 1, further comprising a head adjustment assembly disposed on the first housing and/or the second housing, wherein, when the head adjustment assembly is operated, the head assembly is rotatable relative to the trunk assembly.

6. The cutting tool according to claim 5, further comprising a main switch disposed on the first housing, wherein, when the head adjustment assembly is operated, the main switch is prevented from being operated.

7. The cutting tool according to claim 1, further comprising a cutting shield and a shield accessory wherein the cutting shield covers the cutting piece in a radial direction and is rotatable about the output shaft, the shield accessory is detachably mounted on the cutting shield, and at least one dust suction pipe is detachably mounted on the shield accessory.

8. The cutting tool according to claim 1, further comprising a third contact surface, wherein, when the third contact surface is in contact with the workpiece, the cutting piece has the maximum cutting depth.

9. The cutting tool according to claim 8, wherein a projection of the third contact surface on a plane perpendicular to the first axis is located between a projection of the first contact surface on the plane and a projection of the second contact surface on the plane.

10. The cutting tool according to claim 9, further comprising a cutting shield covering the cutting piece in a radial direction and rotatable about the output shaft, wherein the third contact surface is disposed on the cutting shield or the third housing.

11. The cutting tool according to claim 8, wherein when observed in a plane perpendicular to the first axis, the first contact surface is tangent to the third contact surface, and the second contact surface is tangent to the third contact surface.

12. The cutting tool according to claim 7, wherein a projection of the cutting shield to a plane perpendicular to the first axis along a direction of the first axis has a first shield edge and a second shield edge, the first shield edge is substantially parallel to the first contact surface when the cutting shield is at a first limit position, and the second shield edge is substantially parallel to the second contact surface when the cutting shield is at a second limit position.

13. The cutting tool according to claim 1, further comprising a third contact surface disposed on the third housing, wherein, when the third contact surface is in contact with the workpiece, the cutting piece reaches the maximum cutting depth.

14. The cutting tool according to claim 13, wherein the third contact surface is configured to be an arc-shaped surface with a fixed radius of curvature greater than or equal to 13 mm.

15. A handheld tool, comprising:
a trunk assembly comprising at least a first housing for a hand grip;
a head assembly comprising an electric motor coupled to a motor shaft; a second housing configured to accommodate the electric motor; an output shaft to which a cutting piece for cutting a workpiece is mounted and extending along a first axis; and a transmission assembly accommodated in a third housing, connected between the motor shaft and the output shaft, and configured to transmit a drive force from the electric motor to the output shaft;
a cutting shield covering the cutting piece in a radial direction and rotatable about the output shaft relative to the second housing, wherein the cutting shield is adjustable between a first limit position and a second limit position, which are two limit positions reachable by the cutting shield rotating about the output shaft in opposite directions; the third housing has a first contact surface with the workpiece when the cutting shield is at the first limit position; and the third housing has a second contact surface with the workpiece when the cutting shield is at the second limit position; and
a third contact surface disposed on the third housing, wherein, when the third contact surface is in contact with the workpiece, the cutting piece reaches a maximum cutting depth, and the third contact surface is configured to be an arc-shaped surface with a fixed radius of curvature greater than or equal to 13 mm.

16. The handheld tool according to claim 15, wherein a projection of the third contact surface on a plane perpendicular to the output shaft is located between a projection of the first contact surface on the plane and a projection of the second contact surface on the plane.

17. The handheld tool according to claim 15, wherein when observed in a plane perpendicular to the output shaft, the first contact surface is tangent to the third contact surface, and the second contact surface is tangent to the third contact surface.

18. The handheld tool according to claim 15, wherein a projection of the cutting shield to a plane perpendicular to the first axis along the first axis has a first shield edge and a second shield edge, the first shield edge is substantially parallel to the first contact surface when the cutting shield is at the first limit position, and the second shield edge is substantially parallel to the second contact surface when the cutting shield is at the second limit position.
